(19) United States
(12) Patent Application Publication
(10) Pub. No.: US 2004/0168002 A1
(43) Pub. Date: Aug. 26, 2004

(54) Method for the processing of command signals within an audiovisual network, corresponding device, network and computer program

(75) Inventors: Jean-Paul Accarie, Vern Sur Seiche (FR); Mohamed Braneci, Rennes (FR); Herve Merlet, Servon Sur Vilaine (FR)

Correspondence Address: FITZPATRICK CELLA HARPER & SCINTO, 30 ROCKEFELLER PLAZA, NEW YORK, NY, 10112, US

(73) Assignee: Canon Europa NV, Amstelveen (NL)

(21) Appl. No.: 10/763,272

(22) Filed: Jan. 26, 2004

(30) Foreign Application Priority Data
Feb. 18, 2003 (FR) 03 01987

(51) Int. Cl. G06F 13/10

(52) U.S. Cl. 710/62

(57) ABSTRACT

A method for the processing of control signals within an audiovisual network comprises at least one element (20) liable to send a digital command signal to at least one peripheral (181, 182), called an analog peripheral, designed to receive analog commands. The processing method implements, in a conversion device (241, 242), a conversion (92) of the digital command signal into at least one of the analog commands, said conversion being selectively configured as a function of said peripheral.

### BACKGROUND OF THE INVENTION

1. Field of the Invention

The field of the invention is that home audiovisual networks of the type used to interconnect a plurality of audio and/or video analog and/or digital type terminals (also called devices) so that they exchange audiovisual signals and/or commands.

These terminals belong, for example, to the following list of equipment (which is not exhaustive): television receivers (using satellite, RF channels, cable, xDSL and other means), television sets, video recorders, scanners, analog and/or digital camcorders, digital cameras, CD and/or DVD readers, computers, personal digital assistants (PDAs), printers, etc.

The home audiovisual network is for example of the high-bit-rate, switched network type comprising a certain number of nodes, used especially for the real-time exchange of moving pictures for distribution within a dwelling.

A home audiovisual network according to the invention comprises a plurality of serial communications buses working according to the IEEE 1394 standard. The buses are attached to a federating or backbone network through devices called <<nodes>>. The backbone network is, for example, a high-bit-rate, switched type of network used for two-way transfers of data according to the IEEE 1355 standard. The backbone network can also be of the serial type according to the IEEE 1394b or Ethernet standard. It can also be a non-filary network and may use, for example, a radio type medium according to the IEEE 802.11 or ETSI BRAN HiperLAN/2 standards.

Audio and/or video terminals communicate with one another through the nodes to which they are connected. The nodes that form the skeleton of the network comprise especially:

first interface means enabling the connection, through one or more links (for example according to the IEEE 1355 standard), of one or more other nodes;

second interface means used for the connection of one or more analog terminals (namely terminals capable of receiving audiovisual signals in analog form);

third interface means used for the connection (for example through a digital bus according to the IEEE 1394 standard) of one or more digital terminals (namely terminals capable of receiving audiovisual signals in digital form).

In a home audiovisual network of this kind, a connection is set up, through a plurality of nodes, between a first terminal (or listener) that seeks to receive audiovisual signals and a second terminal (or talker) that can give it these signals.

Some elements of the terminology used hereinafter in the description shall now be specified.

The first terminal mentioned here above is called a “destination terminal” and the node to which it is connected is called an “output node”. The second terminal mentioned here above is called a “source terminal” and the node to which it is connected is called an “input node”. The destination and source terminals may be integrated, but are not necessarily integrated, into the nodes to which they are connected, the output and input nodes respectively.

The term “source terminal” is understood to mean for example a digital camcorder, a digital camera, a digital output DVD reader or any analog device seen through an analog/digital converter. The term “destination terminal” is understood to mean, for example, a digital television set, a storage disk or any analog device seen through a digital/analog converter.

Conventionally, the analog and/or digital terminals of such networks are associated with control devices, generally of the remote-control type enabling them to be controlled at a distance. Thus, a user for example may check the actions of reading, freeze frames or rewinding of a video recorder by means of an infrared remote control with a range of some meters. The digital terminals may also be associated with analog remote-control type control devices, as well as other types of control devices such as controllers that are linked to the terminals by the communications network, and send digital commands through this network For example, the specifications published by the “1394 Trade Association” (“AV/C Digital Interface Command Set, General Specifications, version 3.0; 15 Apr 1998”) define a set of digital commands for the control of audio/video devices connected by an IEEE 1394 device.

Now, in the context of a home audiovisual network of this kind, it is also necessary to give a remote controller terminal the possibility of controlling an analog terminal placed at a distance (typically located in another room of the house or apartment).

The invention therefore relates more specifically to the management, within a home audiovisual network, of the conversion of digital control signals into analog control signals.

2. Description of the Prior Art

The international patent application WO 00/58925 describes a system for the remote control of an apparatus based on wireless data transmission using especially repeaters to go from one room to another. According to this technique, an activation unit receives a radio command and converts it into an infrared command according to instructions contained in the command itself. The drawbacks of this technique are lack of flexibility and complexity of implementation in the apparatus that sends out the command.

The patents GB2342797 by the firm Samsung (registered mark) and US20020002645 by the firm Tokyo Shibaura (registered mark) present converters of IEEE 1394 digital signals into analog signals intended for peripherals to which they are connected. One drawback of these prior arts techniques is that they do not enable any conversion of commands, but only a conversion of the transmission protocols used to carry these commands. Indeed, a command, “Play” for example, is not encoded in the same way when it is a digital command AV/C or an infrared analog command. Thus, these prior art techniques do not offer any solution when they have to carry a command from an item of digital equipment to an item of analog equipment.

According to other prior art techniques, two types of distinct command signals are implemented within a home audiovisual network, and the type of signal received is analyzed in a node of the network in order to decide on the processing operation to be applied to it.

FIG. 1 is a block diagram of a multimedia type home audiovisual network of this kind enabling the interconnection of several types of audio/video apparatuses to one another. It accepts digital or analog type apparatuses at its nodes or connectors.

This network, which is known per se, comprises:

a set of audiovisual or computer equipment interconnected by links, for example of the Ethernet, IEEE1394 and/or IEEE 1355 type, forming a home sub-network 13;

a wall-plate 12 possessing, firstly, at least one IEEE 1394 (input/output) connector and, secondly, at least one output-only infrared (IR) connector;

two analog-digital converters (two-way converters where the data conversion can be done in both directions) 141 and 142 connected to the wall-plate 12 through an IEEE 1394 bus 151;

two analog peripherals 181 and 182 for example of the VCR (video recorder) or satellite tuner type.

According to the prior art, the two peripherals 181 and 182 respectively are connected to:

a converter 141 and 142 link through an analog link 171 and 172 respectively; and

the wall-plate 12 through a wire link or an infrared (IR) wireless link 161 (connected to the infrared connector of the wall-plate 12).

Since each of the converters 141 and 142 is an IEEE 1394 peripheral, it possesses configuration information (configROM or “configuration ROM”) whose addresses are defined especially in the P1212 standards (standard specified in the document “P1212 Draft Standard for a Control and Status Registers (CSR) Architecture for microcomputer buses (Draft 2.0, Jun. 13, 2001)”) and IEEE 1394 (standard specified in the documents “IEEE Std 1394-1995, Standard for High Performance Serial Bus” and “IEEE Std 1394a-2000, Standard for High Performance Serial Bus—Amendment I” published by the IEEE).

Each of the infrared links enables the transmission of IR signals coming from the wall-plate 12 to the associated analog peripheral 181 or 182; the system for the transmission of the infrared signals from the wall-plate 12 comprises a (1-to-n) wire demultiplexer, each of the outputs of the demultiplexer being associated with an infrared connector to which a wire link is connected. The other end of this wire link has a patch bonded to the IR receiver of the associated analog peripheral. This link is thus adapted to conveying IR signals to the associated analog peripheral 181 or 182.

Thus, when a peripheral 10 compatible with the IEEE1394 standard located in the home network 13 wishes to use the services of the analog peripheral 181, it will first search for the configuration information on the converter 141 to which the peripheral 181 is connected (this information is used to determine the functions and the type of protocol used to exchange data with the converter peripheral). Then, the peripheral 10 uses services offered by the wall-plate 12 in order to send out IR commands/signals to the peripheral 181.

This approach has several drawbacks. An infrared command may be received by a peripheral for which it is not intended (this is the case for example when two identical video recorders are connected to the wall-plate 12).

Furthermore, in the case of configuration information (ConfigROM) that is predefined and generic (i.e. does not depend on the apparatuses controlled) at the converter peripheral 141 or 142, this peripheral cannot precisely reflect the properties and/or the capacities of the peripheral to which it is connected (and this holds true also for the IEEE 1394 peripherals located on the same 1394 bus as the converter peripheral).

Furthermore, for an IEEE 1394 peripheral located on the same IEEE 1394 bus as the converter peripheral, it is not planned to be able to directly generate infrared commands designed for the analog peripheral (without using any explicit conversion command through the wall-plate 12).

### SUMMARY OF THE INVENTION

It is a goal of the invention especially to overcome these drawbacks of the prior art.

More specifically, it is a goal of the invention to provide a device and a method for the processing of digital control signals intended for a peripheral (for example an audio and/or video peripheral) with analog inputs/outputs enabling efficient and targeted transmission of the commands.

It is another goal of the invention to implement digital command transmission that is reliable and adapted to the destination peripheral with at least one analog input.

It is also a goal of the invention to enable the control, from a digital network, of any type of peripheral accepting only analog commands.

To this end, the invention proposes a method for the processing of command signals within an audiovisual network comprising at least one element liable to send a digital command signal to at least one peripheral, called an analog peripheral, designed to receive analog commands, wherein the method implements, in a conversion device, a conversion of the digital command signal into at least one of the analog commands, the conversion being selectively configured as a function of the peripheral.

An element of the network, liable to send a digital command signal, may be of any type and is, for example, a node or a terminal (especially a computer, dedicated equipment, remote control etc.) belonging to the audiovisual network.

The analog peripheral here is any peripheral whatsoever (for example, a camcorder, a videotape recorder, a television set, an optical medium reader etc.) possessing at least one analog command input.

According to a particular characteristic of the method, the conversion device implements the following steps:

the storage of at least one piece of configuration information representing the peripheral;

the reception of the digital command signal;

the conversion of the digital command signal into an analog command signal taking account of the piece or pieces of configuration information; and

the transmission of the analog command signals to the analog peripheral.

According to a particular characteristic, the method comprises an initial step for the transmission of the piece or pieces of configuration information of the peripheral to the conversion device.

Thus, the storage of the configuration is reliable and consistent with the peripheral associated with the processing device.

According to a particular characteristic, the method comprises a step for the reading, by the device, of the piece or pieces of configuration information on a detachable data carrier.

Thus, it is relatively simple to update the configuration.

According to a particular characteristic of the method, the reading itself comprises a step for the decoding of mechanical elements belonging to the carrier and representing the peripheral.

Thus, the carrier comprises mechanical elements (for example, hollows, humps and/or scalloped features) enabling easy decoding, for example by a set of switches.

Means for reading the carrier can advantageously be implemented in the command signal processing device in association with means for the analog connection of the peripheral.

According to a particular characteristic of the method, the carrier belongs to the group comprising:

smart cards;

magnetic carriers; and

optical carriers.

Thus, the carrier may comprise both a low-capacity memory zone (a few bits indicating, for example, the type and/or the model of the peripheral) and a high-capacity memory zone (enabling the storage of a fill command conversion table).

According to a particular characteristic of the method, the conversion device implements a step to verify the validity of the digital command signal as a function of the piece or pieces of configuration information.

Thus, no unnecessary or inappropriate command is transmitted to the peripheral.

According to a particular characteristic of the method, the conversion device is independent of the audiovisual network element or elements and of the analog peripheral or peripherals.

Thus, the conversion device is separated from the sender of a digital command and from the analog peripheral to which the corresponding analog command is sent. The method thus enables simple and flexible implementation

According to a particular characteristic, the method comprises a step for the storage of at least one piece of conversion information representing a set of commands accepted by the peripheral.

According to a particular characteristic of the method, the pieces of conversion information are transmitted preliminarily by one of the elements of the network to the conversion device.

Thus, the pieces of conversion information are downloaded into the processing device automatically, when required by the device and/or when requested by the user. The network element is, for example, a dedicated server or any node whatsoever. It may keep a set of several conversion tables in its memory, each table corresponding to a peripheral, or it may download the conversion information from a remote database (for example an Internet site associated with the distributor or manufacturer of the peripheral) before communicating this information to the processing device.

According to a particular characteristic, the method comprises a step for the reading, by the conversion device, of the piece or pieces of configuration information on a detachable data carrier.

Thus, the invention is relatively simple to implement. In particular, the detachable carrier may be an optical, magnetic and/or smart card type of carrier. It may comprise one or more conversion tables as a function of different possible formats of digital command signals.

According to a particular characteristic of the method, the digital command signal is of the IEEE 1394 type.

According to a particular characteristic, the method comprises a step for the storage of data representing a configuration associated with the peripheral in a directory of the conversion device, the directory being compatible with the ConfigROM IEEE 1394 format.

Thus, the invention is particularly well suited to audiovisual networks implementing the IEEE 1394 standard and more particularly networks in the ConfigROM configuration format proper to this standard.

According to a particular characteristic of the method, the analog command signal is of the wireless type.

Thus, the invention is compatible with most existing analog commands.

According to a particular characteristic of the method, the signal is of the infrared type.

Thus, the invention enables the transmission of a command readable by an infrared port of the peripheral. More precisely, the invention does not require any particular adaptation of the peripheral: for the peripheral, there is no difference between a command received directly through a remote-control device associated with the peripheral and a command sent out by the infrared processing device (through a wireless interface or through an optical fiber connecting the processing device to an infrared port of the peripheral).

According to a particular characteristic of the method, the pieces of data associated with the analog command signal are sent to the peripheral on the same transmission carrier.

Thus, the data and the analog commands (for example video data associated with a recording command intended for a video recorder type peripheral) may be transmitted on a same wireless or wire-based carrier. By way of an illustration, the method may implemented by means for the analog multiplexing (especially frequency and/or time multiplexing) of the data and commands sent, and means of analog demultiplexing in reception so that the destination peripheral can properly take account of the data and commands.

According to a particular characteristic of the method, pieces of data associated with the analog command signals are transmitted to the peripheral on a distinct transmission carrier.

Thus, the data may be transmitted at high bit rates, for example on a wire link (especially video type data on an audio/video analog cable) and commands may be transmitted through an infrared link.

According to a particular characteristic of the method, the peripheral belongs to the group comprising:

camcorders;

television sets;

video recorders;

optical carrier readers; and

set-top boxes.

The invention also relates to a device for the processing of command signals within an audiovisual network comprising at least one element of the network liable to send a digital command signal to at least one peripheral, called an analog peripheral, designed to receive analog commands, wherein the device comprises means for the conversion of the digital command signal into at least one of the analog commands, the conversion being selectively configured as a function of the peripheral.

According to a particular characteristic, the device comprises the following means:

means for the storage of at least one piece of configuration information representing the peripheral;

means for the reception of the digital command signal;

means for the conversion of the digital command signal into an analog command signal taking account of the piece or pieces of configuration information; and

means for the transmission of the analog command signals to the analog peripheral.

According to a particular characteristic, the device comprises means for the initial reception of the pieces or pieces of configuration information of the peripheral transmitted by an element of the network.

According to a particular characteristic, the device comprises means for the reading of the piece or pieces of configuration information on a detachable data carrier.

According to a particular characteristic of the device, the reading themselves comprise means for the decoding of mechanical elements belonging to the carrier and representing the peripheral.

According to a particular characteristic of the device, the carrier belongs to the group comprising:

smart cards;

magnetic carriers; and

optical carriers.

According to a particular characteristic of the device, the conversion device implements means to verify the validity of the digital command signal as a function of the piece or pieces of configuration information.

According to a particular characteristic, the device is independent of the audiovisual network element or elements and of the analog peripheral or peripherals.

According to a particular characteristic, the device comprises means for the storage of at least one piece of conversion information representing a set of commands accepted by the peripheral.

According to a particular characteristic of the device, the pieces of conversion information are transmitted preliminarily by one of the elements of the network to the device.

According to a particular characteristic, the device comprises means for the reading, by the device, of the piece or pieces of configuration information on a detachable data carrier.

According to a particular characteristic of the device, the digital command signal is of the IEEE 1394 type.

According to a particular characteristic, the device comprises means for the storage of data representing a configuration associated with the peripheral in a directory of the conversion device, the directory being compatible with the ConfigROM IEEE 1394 format.

According to a particular characteristic of the device, the analog command signal is of a wireless type.

According to a particular characteristic of the device, the analog command signal is of an infrared type.

According to a particular characteristic, the device comprises means for the transmission of data associated with the analog command signal to the peripheral on the same transmission carrier.

According to a particular characteristic, the device comprises means for the transmission of data associated with the analog command signal to the peripheral on a distinct transmission carrier.

According to a particular characteristic of the deice, the peripheral belongs to the group comprising:

camcorders;

television sets;

video recorders;

optical carrier readers; and

set-top boxes.

The invention also relates to an audiovisual communications network comprising:

at least one peripheral, called an.analog peripheral, designed to receive analog commands;

at least one element liable to send a digital command signal to the analog peripheral; and

at least one command signals processing device comprising means for the conversion of the digital command signal into at least one of the analog commands, the conversion being selectively configured as a function of the peripheral.

The invention also relates to a computer program product comprising program elements, recorded on a carrier readable by at least one microprocessor designed to be implemented in a device for the processing of command signals within an audiovisual network comprising at least one element liable to send a digital command signal to at least one peripheral designed to receive analog commands, wherein the program elements control the microprocessor or microprocessors so that, in the processing device, they carry out a conversion of the digital command signals into at least one of the analog commands, the conversion being selectively configured as a function of the peripheral.

Furthermore, the invention relates to a computer program product, comprising sequences of instructions adapted to the implementation of a method for the processing of command signals as described here above when the program is executed on a computer.

The advantages of the device and of the computer programs are the same as those of the command signal processing method, and are not described in fuller detail.

### BRIEF DESCRIPTION OF THE DRAWINGS

Other features and advantages of the invention shall appear more clearly from the following description of a preferred embodiment, and given by way of the simple, illustrative and non-restrictive example, and from the appended figures, of which:

FIG. 1 is a block diagram of a home audiovisual network known per se;

FIG. 2 is a block diagram of a home audiovisual network according to an embodiment of the invention;

FIG. 3 illustrates a hardware architecture of an analog-digital converter belonging to the network of FIG. 2;

FIG. 4 describes the configuration information (ConfigROM) recorded in the converter of FIG. 3;

FIG. 5 presents tasks of updating of configuration and updating of command conversion updating and command processing implemented by the converter of FIG. 3;

FIG. 6 illustrates the configuration updating task presented with reference to FIG. 5;

FIG. 7 presents an updating of the command conversion information in an analog-digital converter according to the invention;

FIG. 8 described as an exemplary command conversion table implemented in the updating task of FIG. 5;

FIG. 9 presents a command processing operation illustrated with reference to FIG. 5;

FIG. 10 illustrates an exemplary application by which the user of the network of FIG. 2 can update the configuration information (ConfigROM) and command conversion information in the converter presented with reference to FIG. 3;

FIG. 11 shows a hardware architecture of the converter according to one variant of the invention;

FIG. 12 illustrates cards designed to be implemented in association with the converter FIG. 11; and

FIGS. 13, 14a, 14b and 14c present the mechanical structure of the converter of FIG. 11.

### MORE DETAILED DESCRIPTION

The general principle of the invention is based on the implementation of a converter between a digital network and a peripheral with analog inputs/outputs that does not accept the digital commands generated by the network, the converter comprising means for the conversion of digital commands into analog commands which it transmits to the destination analog peripheral, the conversion taking account of the configuration information stored in the converter and representing the connected analog peripheral or peripherals.

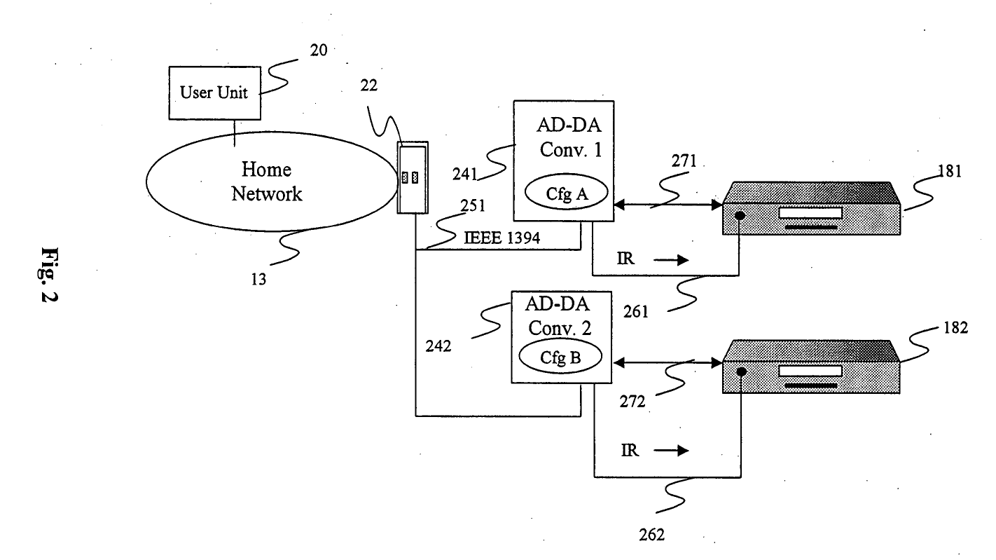

Referring to FIG. 2, we now present a block diagram of a home audiovisual network according to an embodiment of the invention

This network comprises:

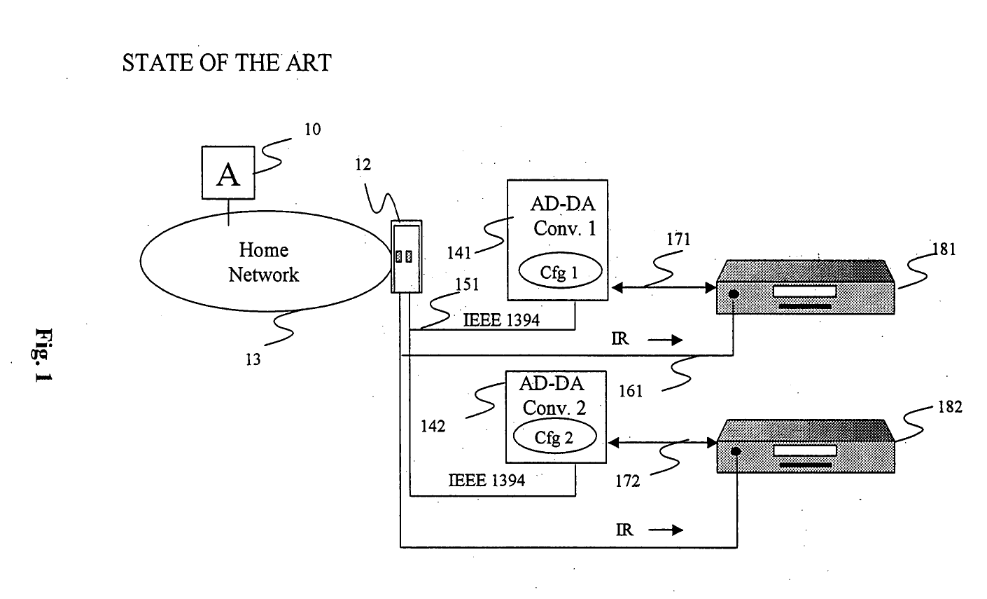

a set of audiovisual or computer equipment interconnected by links such as Ethernet, IEEE1394 and/or IEEE1355, type links forming a home sub-network 13 similar to the sub-network bearing the same reference in FIG. 1;

a wall-plate 22 possessing at least one (input/output) IEEE 1394 connector;

two analog peripherals 181 and 182, for example of the video recorder (VCR) or satellite tuner type; and

two (two-way) analog-digital converters 241 and 242 connected firstly to the wall-plate 22 through an IEEE 1394 bus 251, and secondly to a peripheral, 181 or 182 respectively through infrared (IR) wire links.

According to the invention, the peripheral 181 (and 182 respectively) is connected to a converter 241 (and 242 respectively):

through an analog link 271 (and 272 respectively); and

through an infrared wire link 261 (and 262 respectively) adapted to conveying an infrared command and connecting:

an infrared connector of the converter 241 (and 242 respectively) which itself includes means for sending infrared commands through a wire link, to

a patch bonded to the IR receiver of the associated analog peripheral 181 (and 182 respectively).

Thus, the converter 241 (and 242 respectively) can send and receive analog data through the analog link 271 (and 272 respectively) which can be a high-bit-rate link towards or from the peripheral 181 (and 182 respectively). The converter 241 (and 242 respectively) can also send infrared commands to the peripheral 181 (and 182 respectively) to drive it.

According to a variant which is not shown, the infrared wire link 261 is replaced by an infrared wireless link. Infrared signals could be sent directly by the converter (or conversion device) 241 to the associated peripheral 181.

According to the invention, the information on the configurations of the converters 241 and 242 considered as IEEE 1394 type peripherals can be updated (from another IEEE 1394 peripheral) in order to provide a precise description of the capacities of the connected analog peripheral 181 or 182 (CfgA for the analog peripheral 181, CfgB for the analog peripheral 182). Each of the converters 241 and 242 has its own IEEE 1394 address and can thus be the addressee of a message containing a digital command to be converted and then transmitted in analog form to an analog peripheral to which the converter is connected. Thus a sender of a digital command transmits the command to a converter 241 or 242 (or to both of them) with the corresponding IEEE 1394 address or addresses, the converter or converters that receive the command being responsible for making the appropriate conversion.

By contrast, the driven peripherals 181 and 182 do not have their own IEEE 1394 address (the converters 241 and 242 preferably do not manage any analog peripheral addresses compatible with the IEEE 1394 standard).

Furthermore, the command conversion information can also be updated (from another peripheral) within the converters 241 and 242 as a function of the sets of commands proper to each of the analog peripherals 181 or 182 liable to receive an infrared command. Thus, by way of an illustration, the AV/C “read” or “play” command addressed to the converter 241 is analyzed and then converted into an IR signal compatible with the set of commands of the peripheral 181 and sent to the peripheral 181.

The network 13 includes a peripheral 20 compatible with the IEEE 1394 standard enabling a user to remotely configure the converters 241 and/or 242 as a function of the types of analog peripherals to which they are connected and of the set of commands capable of being transmitted to the analog peripherals associated with the converters.

According to one variant of the invention, a converter is adapted to managing several analog peripherals. Preferably, the converter then comprises pieces of information; on configuration proper to each of the connected peripherals. Furthermore, the converter comprises one or more connectors, each connector enabling the converter to be connected to one or more peripherals. According to a particular mode of implementation of this variant, the converter is adapted to making a choice, according to a determined criterion (such as the matching of the type of command and of peripheral, rotation on different connectors, the configuration of the converter etc.) of a destination peripheral and an associated connector to transmit a analog command converted from a digital command.

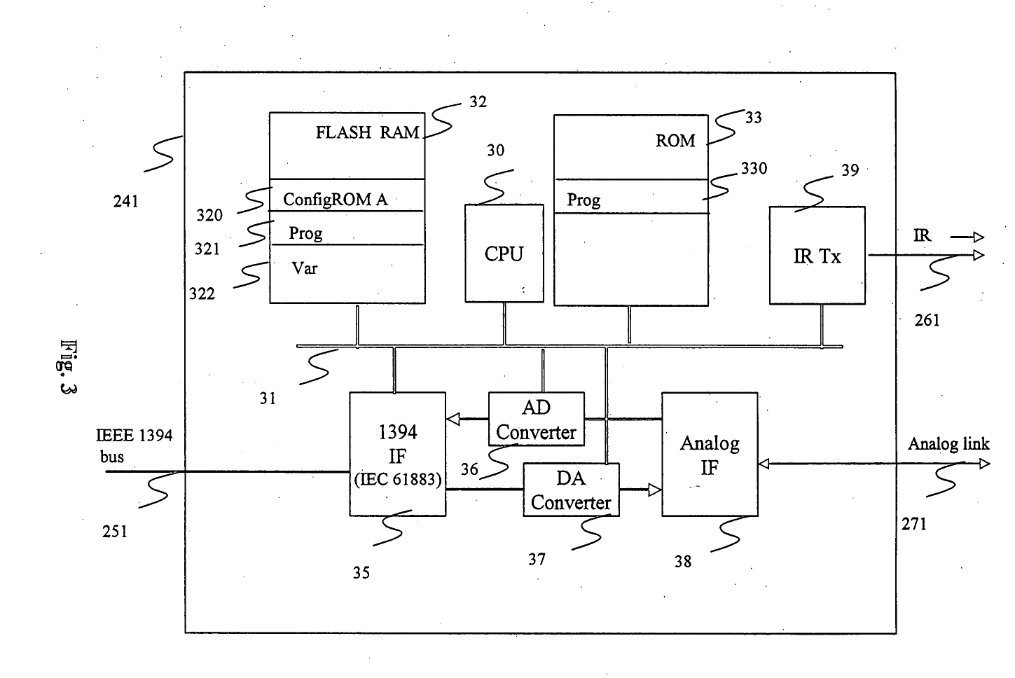

FIG. 3 provides a diagrammatic illustration of the hardware architecture of the converter 241 as illustrated with reference to FIG. 2.

The converter 241 comprises the following elements connected to one another by an address and data bus 31:

a processor 30;

a flash type random-access memory (or battery-saved memory) 32 enabling the keeping of the data including after a period when the converter 241 has not been supplied;

a non-volatile memory 33;

a module 39 for sending IR signals;

an IEEE 1394 input/output interface 35 enabling the connection of the bus 251;

an analog interface 38 enabling the connection of the link 271 (for example a composite cable type link comprising a video link and left-hand and right-hand audio links);

an analog/digital conversion module 36 between the interfaces 38 and 35; and

a digital/analog conversion module 37 between the interfaces 35 and 38.

Each of the elements 30, 32, 33 and 35 to 39 taken in isolation is well known to those skilled in the art. These common elements are not described here.

It will be noted that the word “register” used throughout the description designates, in each of the memories mentioned, a low-capacity memory zone (with some bits) as well as a high-capacity memory zone (enabling the storage of an entire program or the totality of the conversion and/or configuration program).

The non-volatile memory 33 keeps information in registers which, for the sake of convenience, have the same names as the data that they contain. Thus, this non-volatile memory 33 keeps:

the operating program of the processor 30 in a register “prog” 330,

etc.

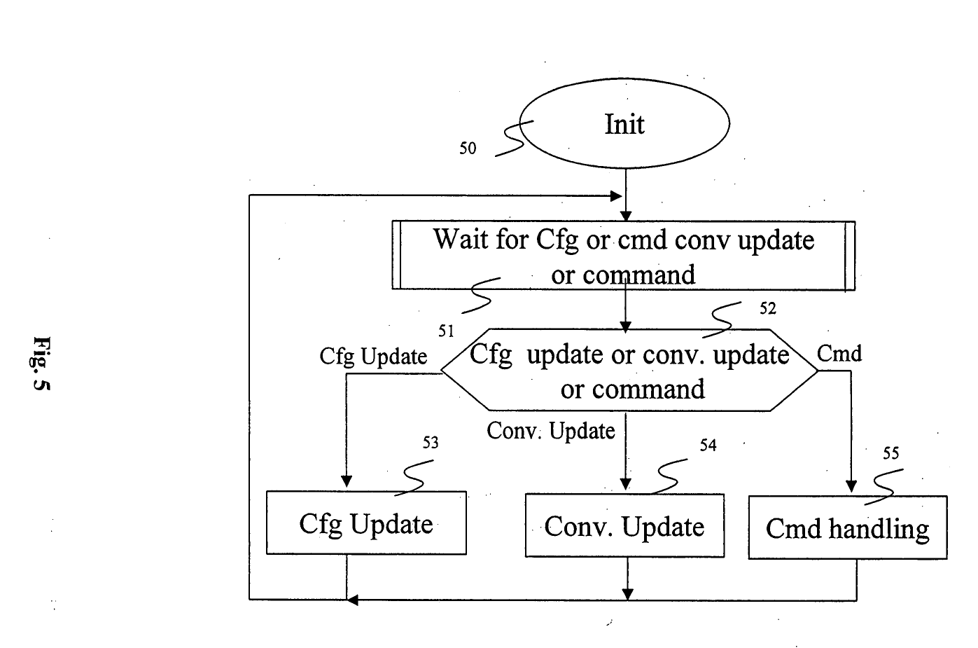

The algorithms implementing the steps of the method described here below, especially with reference to FIGS. 5 to 7 and 9, are stored in the memory 33 associated with the apparatus 241 implementing steps of this algorithm. When the system is powered on, the processor 30 loads and executes the instructions of these algorithms.

The random-access memory 32 comprises especially:

the operating program <<prog >> 321 of the processor 30 loaded when the converter 241 is powered on;

the configurations of each of the peripherals connected to the converter 241, especially the configuration 320 (“ConfigROM”) of the peripheral 181; and

data, variables and intermediate results of processing in a register 322.

Thus, the converter 241 can.manage several analog devices and convert the IEEE 1394 messages intended for the converter 241 (i.e. addressed to it with its own IEEE 1394 address). On the reception of a message containing a command intended for a peripheral, the converter 241 implements means enabling it to associate the command received with a corresponding peripheral configuration (for example configuration 320 for a command intended for the peripheral 181).

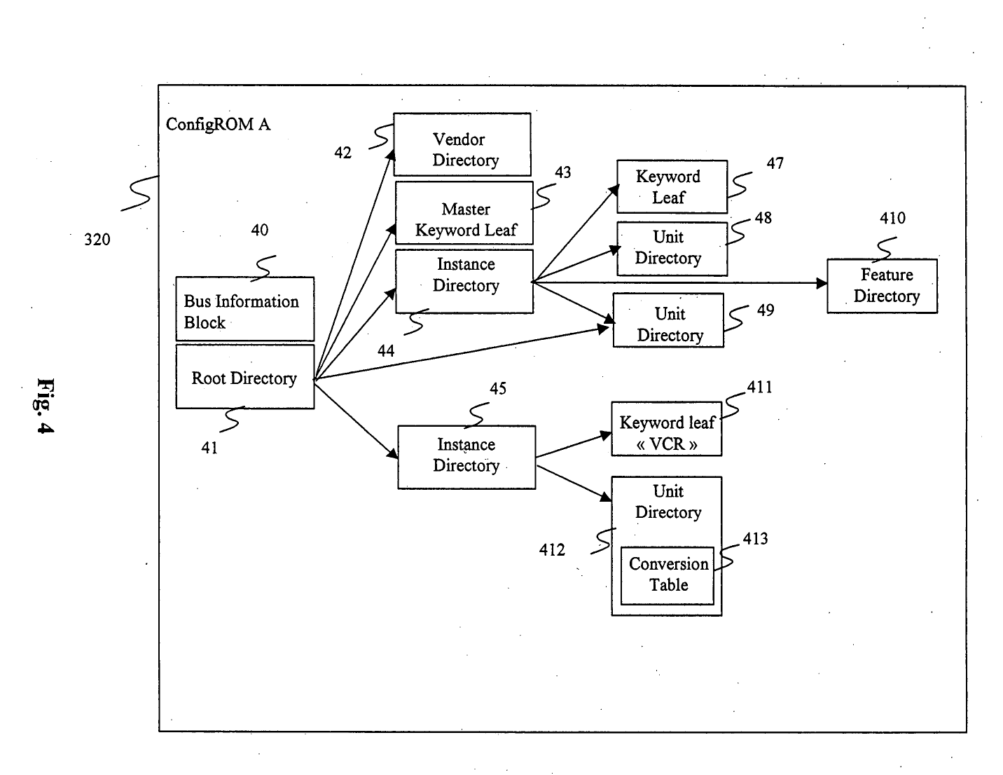

FIG. 4 illustrates the configuration information used to describe the capacities of a 1394 peripheral and especially the configuration information 320 (according to the “ConfigROM” format defined in the IEEE1394 standard) of the peripheral 181 recorded in the flash memory 32 of the converter 241.

The pieces of configuration information of a peripheral according to the ConfigROM format are described in detail in the P1212 standard specified in the document “P1212 Draft Standard for a Control and Status Registers (CSR) Architecture for microcomputer buses (Draft 2.0, Jun. 13, 2001)”). Briefly, these pieces of configuration information can be subdivided as follows:

“bus information block” type information 40 to determine the type of bus used (for example an IEEE 1394 type bus) as well as information on this type of bus, the identifier (GUID or “Global Unique Identifier” or again EUI-64) of the IEEE 1394 peripheral concerned (in this case, the peripheral 181), . . . ; and

“root directory” information 41 containing input points enabling the description of the characteristics of the IEEE 1394 peripheral concerned and the retrieval of any other information on this IEEE 1394 peripheral according to different optional data structures especially instance directory information 44 and 45 which describes functions implemented at the IEEE 1394 peripheral according to a particular implementation of the IEEE 1394 peripheral, this data structure itself containing at least “instance directory” or “unit directory” information and, optionally, a single piece of “keyword leaf” type information and several pieces of “feature directory”, “instance directory” and “unit directory” type information.

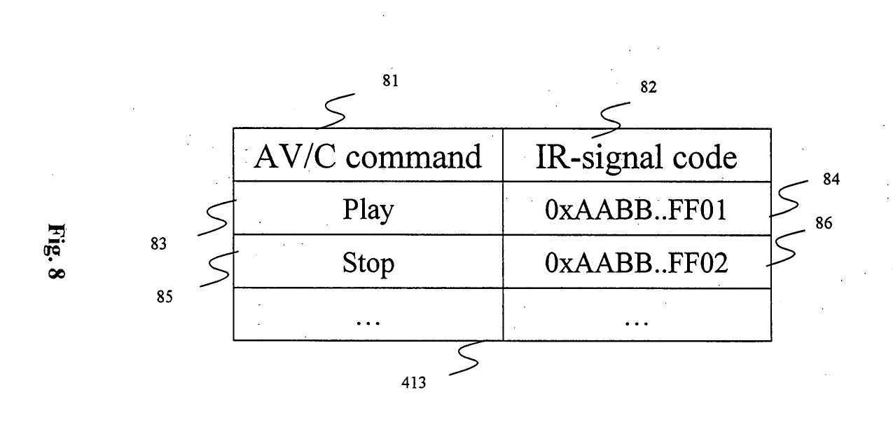

According to the embodiment described, the pieces of configuration information are updated (especially during a connection of a peripheral or before the sending of a command to a peripheral whose type is determined) to specify precisely the characteristics of the analog peripheral 181, connected behind the converter 241. To do this, the peripheral 181 is represented by the functions directory 45 referenced from the root directory 41. This functions directory contains a first pointer towards a keyword directory 411. The keyword contained in this directory is “VCR” (by way of an illustration) and, according to the IEEE 1212 standard, this keyword designates a video recorder. The functions directory also contains a second pointer to a unit directory 412. The unit directory 412 contains a command conversion table 413 described in detail in FIG. 8.

FIG. 5 presents tasks of updating of configuration and/or updating of command conversion information, and tasks of command processing implemented by the converter 241.

During a first step 50, different parameters of the converter 241 are initialized.

Then, during a step 51, the converter 241 goes into standby and then receives a message sent out by an IEEE 1394 peripheral of the network 13 and comprising especially:

information enabling the updating of the configuration of one or more peripherals with which the converter 241 is associated (for example, the peripheral 181);

information enabling the updating of a conversion table of commands intended for one of more peripherals with which the converter 241 is associated and that are compatible with a previously recorded configuration; and/or

a command intended for one or more peripherals with which the converter 241 is associated.

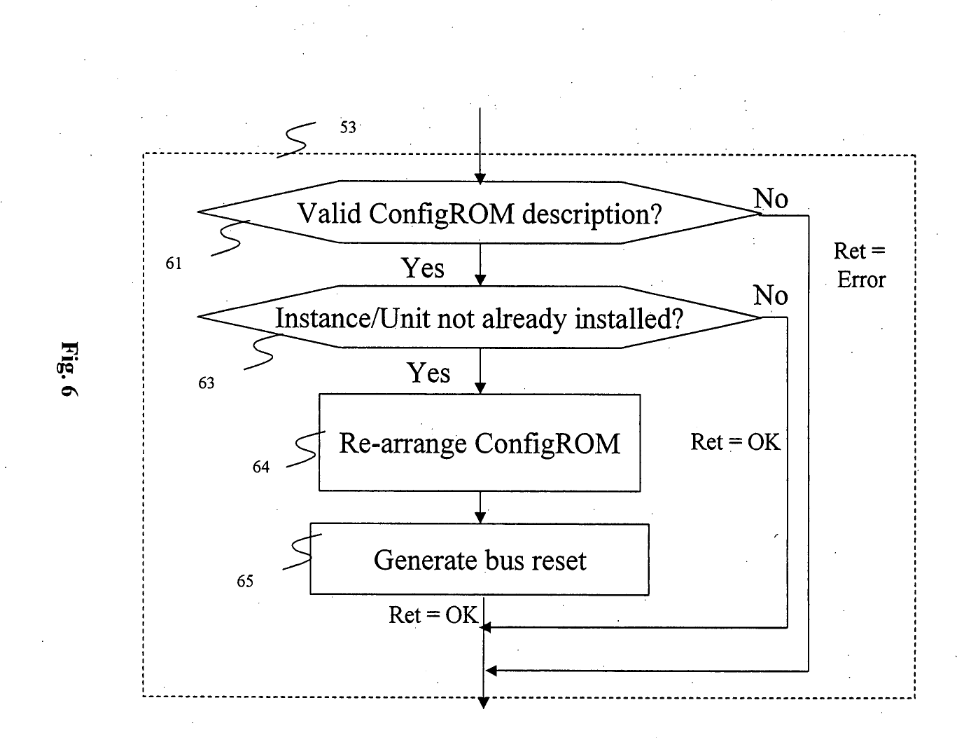

If it receives information, prepared by the network, enabling an updating of configuration, the converter 241 verifies the validity of this information and, as the case may be, updates the configuration of the peripheral or peripherals concerned in a step 53 illustrated in greater detail with reference to FIG. 6.

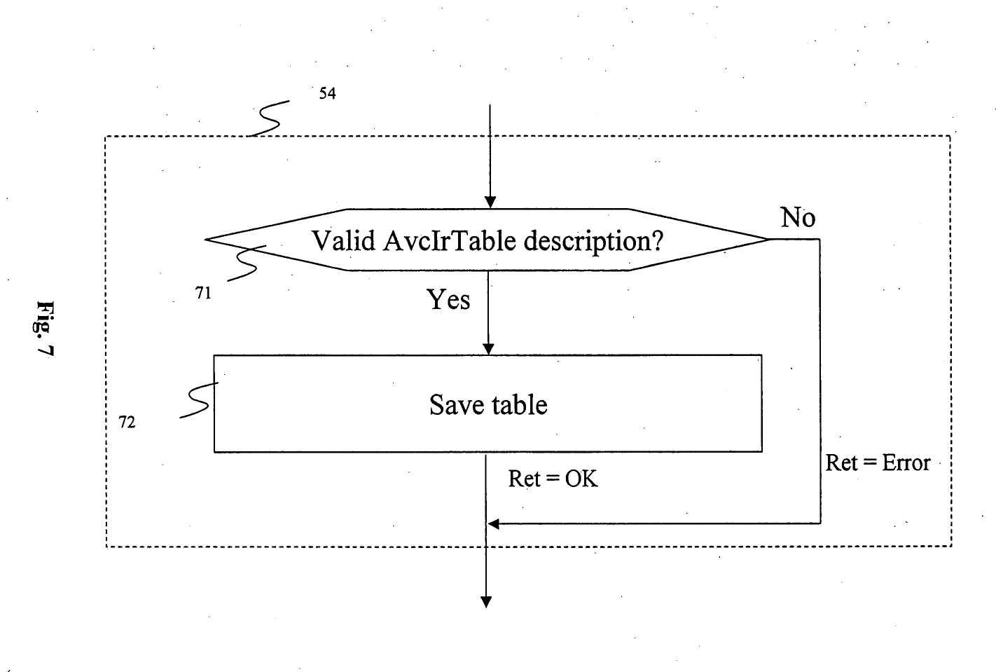

If it receives a piece of information enabling an updating of a command conversion table, the converter 241 verifies the validity of this information and, if necessary, updates the command conversion table associated with each of the peripherals concerned in a step 54 illustrated in greater detail with reference to FIG. 7.

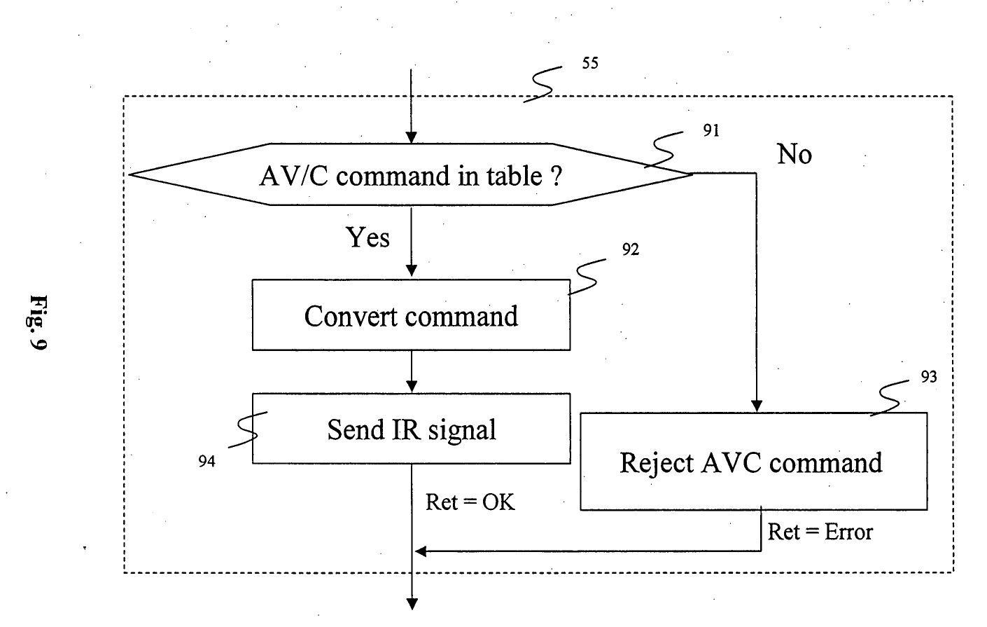

If it receives a command, in a step 55 illustrated in greater detail with reference to FIG. 9, the converter 241 processes this command in verifying its validity and in transmitting a converted command to the concerned peripheral or peripherals as a function of the associated conversion table or tables.

FIG. 6 illustrates an exemplary updating of the configuration information (according to the ConfigROM format) of the peripheral 181 in the converter 241 according to the step 53 presented with reference to FIG. 5.

During the step 51 described here above, pieces of configuration. information are prepared by an IEEE 1394 peripheral of the network 13 and communicated to the converter 241 as a function of the nature of the analog peripheral 181 connected to the converter 241.

The step 53 illustrated here above starts with a step 61 during which the converter 241 verifies the validity of the configuration information received, in accordance with the P1212 standard.

If the configuration information received is not valid, the step 53 ends by returning an error signal.

If the configuration information received is valid then, during a test 63, the converter 241 verifies that some of this information has not already been installed or is already up to date.

If all the information is installed or updated, the step 53 ends without any need for new modifications.

If not, during a step 64, the information on configuration is shaped according to the P1212 standard and saved in the flash memory 32 of the converter 241.

Then, during a step 65, a “bus reset” signal is generated on the IEEE 1394 bus 151 in order to inform the other IEEE 1394 peripherals connected to this bus (in this case the wall-plate 22) that modifications have taken place on the IEEE 1394 bus 151 (in this case, the modifications are the updating of the information on configuration of the converter 241: it is then up to each IEEE 1394 peripheral connected to the bus 151 to run the processing operations following a resetting of this bus). Then, the step 53 ends by returning a signal for taking account of the information received.

FIG. 7 illustrates an exemplary updating of the information on conversion of the commands of the peripheral 181 in the converter 241 according to the step 54 presented with reference to FIG. 5.

During the step 51 described here above, information on conversion of commands of the peripheral 181 compatible with the configuration information transmitted earlier is established by an IEEE 1394 peripheral of the network 13 and communicated to the converter 241 as a function of the nature of the analog peripheral 181 connected to the converter 241.

The step 54 illustrated here above starts with a step 71 during which the converter 241 verifies the validity of the conversion information received, in accordance with the P1212 standard. The converter 241 especially verifies the fact that each entry into the command conversion table is accurately filled: each AV/C command must have a corresponding IR (infrared) signal code according to the format used by the IR signals sender module.

In the event of non-validity of the conversion information, the step 54 ends with the return of an error signal.

If not, during a step 73, the conversion information is saved in the flash memory 32 of the converter 241. The conversion data thus stored could be subsequently used to convert an IEEE 1394 command, intended for the peripheral 181, into an infrared command. Then, the step 54 ends with the return of a signal for taking account of the information received.

FIG. 8 describes an exemplary table 413 relating to the conversion of AV/C type commands into IR signals, implemented especially during the step 54 illustrated with respect to FIG. 7 in the converter 241 and as illustrated with respect to FIG. 4. The command conversion table is used to obtain correspondence between a command used in a standard manner between the IEEE 1394 peripherals (for example, AV/C commands) and data in the format adapted to the analog peripheral that is the destination of the commands (for example strings of ASCH or hexadecimal characters). This data enables the generation of IR signals understood by the analog peripheral. By way of an illustration, the table 413 sets up a correspondence, with the AV/C “read” or “play” command 83, of an infrared command 84 <<0xAABB . . . FF01>> in hexadecimal notation which, if necessary, could be directly interpreted as a “play” command by the peripheral 181. Similarly, the table 413 sets up a correspondence between the AV/C “stop” command 85 and an infrared command 86 <<0xAABB . . . FF02>> in hexadecimal notation, corresponding to the infrared stop command of the peripheral 181.

FIG. 9 illustrates a command processing operation according to the step 55 presented with reference to FIG. 5.

During the step 51 described here above, a command intended for the peripheral 181 is transmitted by an IEEE 1394 peripheral from the network 13 to the converter 241.

The step 55 illustrated here above starts with a test 91 during which the converter 241 verifies the validity of the command received by searching for it in the conversion table associated with the peripheral 181.

When there is no command in the conversion table, the step 55 ends with a step 93 during which the converter 241 rejects the command by generating an appropriate return signal indicating a reception of a command not compatible with the peripheral 181. It may be, for example, a command unknown to (not managed by) the analog peripheral (for example a recording command that can be sent to a peripheral which does not possess any recording means) and/or a table updating problem, a negative status being returned during an implementation of the algorithms illustrated with reference to FIGS. 5 to 7.

If the command received is present in the conversion table, during a step 92, the processor 30 of the converter 241 carries out the conversion as a function of the data present in the previously stored and/or updated conversion table.

Then, during a step 94 terminating the step 55, the code of the corresponding IR signal is then sent to the IR signals sending module 39 which will then take responsibility for generating the IR signal sent to the peripheral 181.

When the received command is accompanied by data (for example a recording command accompanied by data to be recorded), the data is transmitted to the peripheral 181 through the interface 28 and the dedicated link 271.

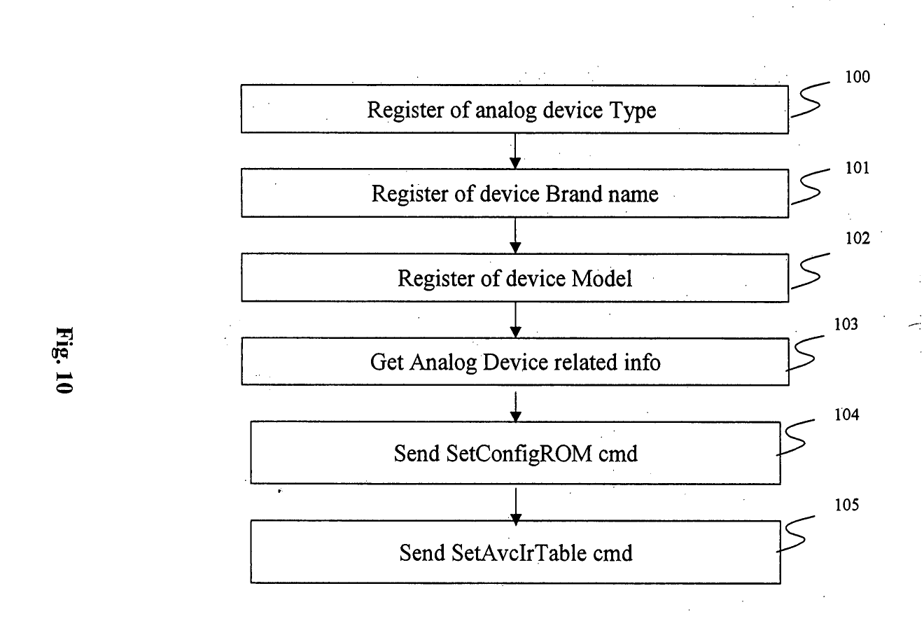

FIG. 10 illustrates an exemplary application enabling a user of the network of FIG. 2 to update configuration information (ConfigROM) and command conversion information in the converter 241.

The user who has just connected the analog peripheral 181 to the converter 241 must proceed to a phase of updating the converter 241 as follows.

The user knows the type of analog peripheral 181 (for example a video recorder), its brand (for example CANON (registered mark)) and possibly its model (for example ABCD1234). Only information on the type of analog peripheral 181 is obligatory. The other pieces of information remain optional.

Thus, in a step 100, the peripheral 20 proposes types of analog peripherals, capable of being controlled (for example, camcorders, video recorders, television sets etc.), to the user, and records the user's choice.

Then, during optional steps 101 and 102, the peripheral 20 proposes optional information to the user. This optional information relates especially to a name of a peripheral, its brand and/or a model corresponding to the type of peripheral chosen at the step 100.

Then, during a step 103, the peripheral 20 searches for information on configurations and/or on command conversions (list of commands and IEEE 1394 table of conversion into the infra-red):

locally;

one or more IEEE 1394 peripherals present in the network 13;

in a dedicated external equipment (for example of the Internet site type maintained, for example, by vendors and/or distributors of analog/digital converter peripherals; and/or

by means of a data carrier reader (especially a carrier of the magnetic card or smart card type) containing the necessary information (carriers are, for example, distributed by vendors/distributors of analog-digital converter peripherals).

Then, during steps 104 and 105, the pieces of information obtained, respectively configuration and command conversion information, are communicated through the network 13 to the converter 241 to be processed according to the steps 53 and/or 54 illustrated here above.

According to one variant of the invention, the information is updated by the user at the converter 241 which then has a man/machine interface and configuration search means and/or adapted conversion means enabling the implementation of steps similar to the steps 100, 103, and, if necessary, 101 and 102 described here above. The steps 104 and 105 are then replaced by steps for the local updating of the flash memory 32.

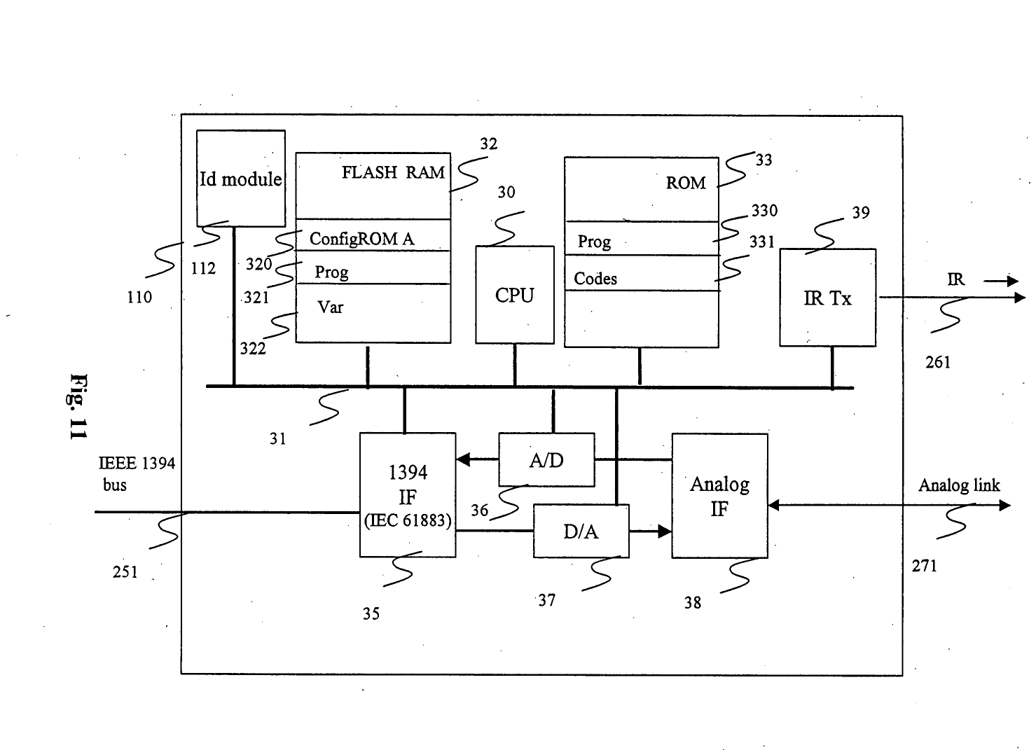

FIG. 11 shows a hardware architecture of a converter 110 according to one variant of the invention.

An identification of a peripheral connected to an apparatus is generally planned in the case of a digital peripheral through the transmission of an identifier in the messages exchanged between the digital peripheral and the apparatus. In the case of an analog apparatus, this identification through exchanged messages is far more difficult. The variant of the invention described with reference to FIG. 11 enables this drawback to be overcome.

In general, a converter according to one variant of the invention comprises means for reading an external data carrier comprising information representing the peripheral with analog inputs/outputs to which it is connected.

More specifically, according to the embodiment of this variant described with respect to FIG. 11, the converter 110 comprises means enabling it to identify the type of apparatus with analog inputs/outputs (for example video recorder, DVD (Digital Video Disk) reader, CD (Compact-Disk) reader, S.T.B. (Set Top Box), etc.) connected to each node.

The converter 110 has an architecture similar to that of the converter 241 illustrated in FIG. 3. The elements common to the converters 241 and 110 shall therefore not be described in greater detail. The converter furthermore comprises:

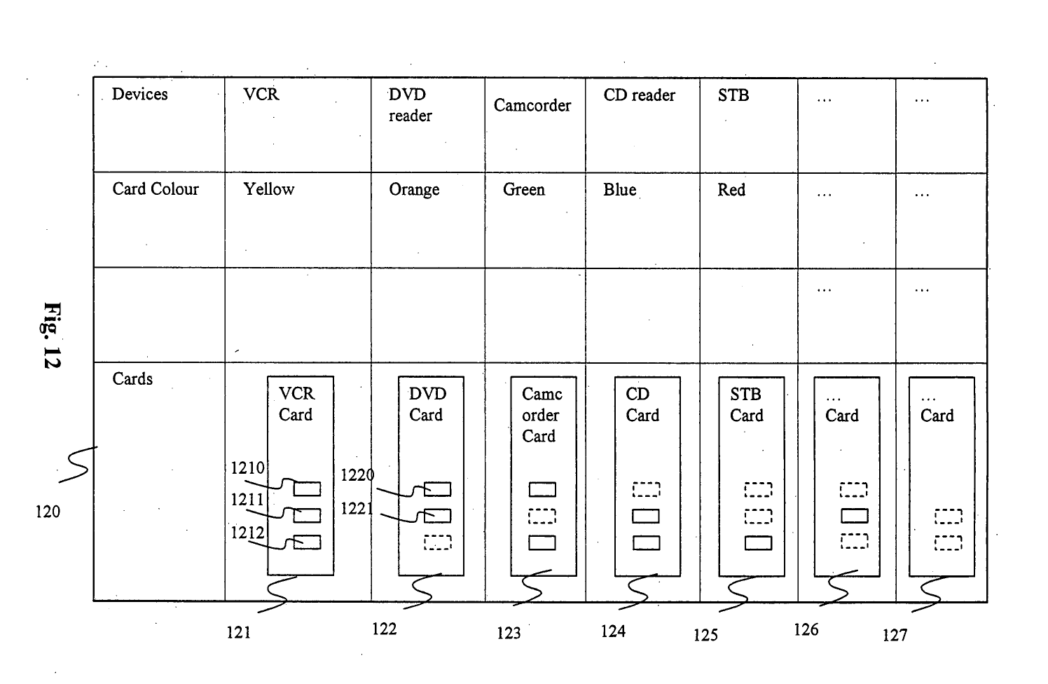

a peripheral identification module 112, that is connected to the bus 31 and is designed for use in association with an external support of the cards presented in FIG. 12; and

codes 331 stored in the non-volatile memory 33 and representing a type of peripheral with analog inputs/outputs liable to be connected to the interface 38.

FIG. 12 illustrates cards 121 to 127 designed to be implemented in association with the converter 110.

Each of the cards 121 to 127 is made of rigid material (for example plastic or the like) and has holes, notches and/or humps (or bossings or protrusions) with which to actuate switches in the identification module 112 when it is introduced into a housing provided for it in an audio/video connector associated with the analog interface 38.

Each of the cards 121 to 127 can easily be identified by a user, for example as a function of its color and/or its screen-printed pattern. It furthermore has one or more holes, notches and/or protrusions representing the type of apparatus, with analog inputs/outputs liable to be connected to the analog interface 38.

By way of an illustration, FIG. 12 describes the correspondence between several configurations of holes in a card, its color and the type of peripherals with analog inputs/outputs with which it is associated. According to one card configuration capable of possessing three dedicated locations with or without holes, eight possible combinations are obtained, enabling the identification of eight different types of apparatus.

Thus, the card 121 representing a video recorder possesses the following characteristics:

it is green with an adapted screen-print (for example mentioning the brand, the model and/or the manufacturer of the associated apparatus) enabling the user to acknowledge that it is a card associated with a video tape recorder; and

the three dedicated locations are pierced.

Similarly, the card 122 representing a DVD reader is orange and only the first two dedicated locations are pierced.

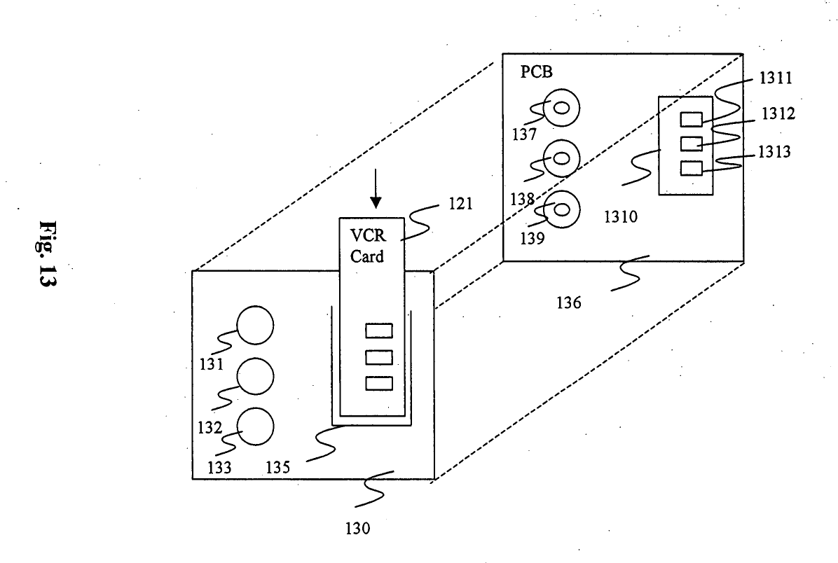

FIG. 13 illustrates the mechanical structure of the converter 110 comprising a front face 130 enabling the connections to an analog apparatus and an electronic card 136 designed to provide the electrical interfaces.

The electronic card 136 comprises especially:

three audio-video RCA connectors 137 to 139 enabling the connection of audio-video cables to an audio-video peripheral and belonging to the analog interface 38; and

a set 1310 of three switches 1311 to 1313, each being designed to be associated with a location dedicated to a card such as is shown with reference to FIG. 12 and capable of taking an open or closed position as a function of the presence or absence of a hole in the dedicated location facing the switch.

The front face 130 comprises especially:

three holes 131 to 133 designed to receive the RCA connectors 137 to 139; and

a card support 135 that makes it possible to receive one of the cards 121 to 127.

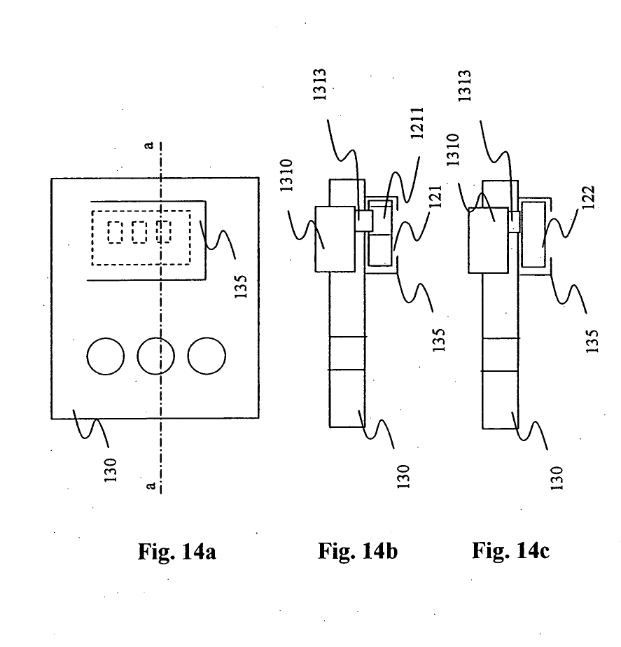

FIG. 14a to 14c shows the mechanical structure of the converter 110 and, more specifically, a front view and a cross-section view with two different switch positions.

The detailed section aa of FIGS. 14b and 14c is made at the last dedicated location when a card is housed in the support 135 (Cf. FIG. 14a).

According to FIGS. 14b and 14c, the support 135 has ridges through which a card can easily be introduced by the support, and held in position. According to FIG. 14b, when a card 121 is introduced into the support 135, the switch 1313 gets housed in the hole 1212 corresponding to the last location of the card 121. The switch is then in the open position.

According to FIG. 14c, when a card 122 is introduced into the support 135, the switch 1313 remains in the closed position, and is limited in its travel by the filling of the last dedicated location of the card 122 (there is no hole at this location).

The switch 1313 is thus suited to identifying the presence or absence of holes in the last dedicated location of a card inserted into the carrier 135. The switches 1311 and 1312 are similarly adapted to identifying the presence or absence of holes in the first two dedicated locations of a card inserted into the support 135. The open or closed states of the switches 1311 and 1312 therefore enable the unambiguous and simple-to-implement decoding of the cards liable to be inserted into the support 135, the corresponding codes 331 being first of all recorded in the memory 33 of the converter 110.

In short, after having connected an apparatus with analog inputs/outputs to the audio/video RCA input connectors 137 to 139 (for example a DVD reader), a user slides a card 122 (orange for the DVD reader) into the support 135.

The action of sliding the card 122 enables a change in state of the switches 1311 to 1313 (open=1, closed=0) which may therefore be read by the microcontroller 30 and interpreted as a function of the recorded codes 330.

The information on “connection of a DVD reader to the analog connector” is transmitted to management means of the network 13. This automatically activates the display, for example on a television screen (connected to the network 13), of a menu of configuration and assistance to the user indicating the connection of a DVD reader. The user is offered the possibility of refining the identification of the connected apparatus (for example its brand and/or its model). Thus, after the type of apparatus has been identified, and possibly after the entry of more precise information, the management means of the network 13 transmit configuration information and/or command conversion information to the converter 110 which then processes them according to the algorithms illustrated with reference to FIGS. 5 to 7, this information being generated by the network management means as a function of the type of apparatus identified and of locally prerecorded and/or downloaded data. Then, the converter 110 can process the received commands through the network 13 and use the appropriate IR commands according to the processing algorithm illustrated in FIG. 9.

Naturally, the invention is not limited to the exemplary embodiments mentioned here above.

In particular, those skilled in the art can provide any variant in the implementation of the means for the conversion of a first digital command into a second command intended for a peripheral with analog inputs/outputs.

It will be noted that the medium enabling the transmission of commands between the converter and the peripheral with analog inputs/outputs cannot be limited to the infrared range but can be extended to any analog wireless medium (especially of the type using radio, ultrasound, carrier current etc) or analog wire-based system.

Furthermore, the commands that are intended for an analog peripheral and are converted may or may not be accompanied by data which, according to the invention, may itself be transmitted through the same medium as the commands or through a distinct medium (in particular, a medium dedicated to data transmission, for example audio and/or video data transmission). The data exchanged may be transmitted, according to the invention, in a link that may be one-way, two-way, upward (peripheral to converter) or downward (converter to peripheral), working at low or high bit rates.

The means of configuration of the converter, as a function of the connected peripheral or peripherals, may also be implemented with a wide variety of means, especially with digital network management means connected through the network or a direct link with the converter. This may be equipment that may or may not be dedicated. The configuration means may also form part of the converter itself

The information enabling the conversion of the digital commands may be stored in the converter, a digital network management equipment connected to the converter or again in another network (for example of the Internet type), a detachable carrier (such as a floppy, CD-ROM, DVD-ROM, smart card, magnetic card, optical card, etc).

Those skilled in the art can also make any variant in the identification of the analog peripherals, especially by man/machine interface with or without pre-recorded data or by a detachable carrier (such as a smart card, optical card, magnetic card, card with holes, notches and/or protrusions). The identification of the analog peripherals can be done, according to the invention, within the converter and/or a network equipment connected to the converter. The means for the automatic identification of peripherals (for example of the carrier type with recorded data) may comprise several pieces of data on the model of peripherals or, on the contrary, a vast set of data (for example, the entire conversion table of an analog peripheral)

It will be noted that the invention cannot be limited to a purely hardware layout but that it can also be implemented in the form of a sequence of instructions of a computer program or any other form combining a hardware part and the software part. Should the invention be partially or totally laid out in software form, the corresponding instructions sequence could be stored in a storage means that may be detachable (such as, for example, a floppy, a CD-ROM or a DVD-ROM) or not detachable, this storage means being partially or totally readable by a computer or a microprocessor.

What is claimed is:

1. A method for the processing of command signals within an audiovisual network comprising at least one element liable to send a digital command signal to at least one peripheral, called an analog peripheral, designed to receive analog commands, wherein the method implements, in a conversion device, a conversion of said digital command signal into at least one of said analog commands, said conversion being selectively configured as a function of said peripheral.

2. A method according to claim 1, wherein said conversion device implements the following steps:
the storage of at least one piece of configuration information representing said peripheral;
the reception of said digital command signal;
the conversion of said digital command signal into an analog command signal taking account of said piece or pieces of configuration information; and
the transmission of said analog command signals to said analog peripheral.

3. A method according to claim 2, comprising an initial step for the transmission of said piece of configuration information or said pieces of configuration information of said peripheral to said conversion device.

4. A method according to claim 2, comprising a step for the reading, by said device, of said piece or pieces of configuration information on a detachable data carrier.

5. A method according to claim 2, wherein said method comprises a step for the reading, by said device, of said piece or pieces of configuration information on a detachable data carrier and wherein said reading itself comprises a step for the decoding of mechanical elements belonging to said carrier and representing said peripheral.

6. A method according to claim 2, wherein said method comprises a step for the reading, by said device, of said piece or pieces of configuration information on a detachable data carrier and wherein said carrier belongs to the group comprising:
smart cards;
magnetic carriers; and
optical carriers.

7. A method according to claim 2, wherein said conversion device implements a step to verify the validity of said digital command signal as a function of said piece or pieces of configuration information.

8. A method according to claim 1, wherein said conversion device is independent of said audiovisual network element or elements and of said analog peripheral or peripherals.

9. A method according to claim 1, comprising a step for the storage of at least one piece of conversion information representing a set of commands accepted by said peripheral.

10. A method according to claim 9, wherein said pieces of conversion information are transmitted preliminarily by one of said elements of the network to said conversion device.

11. A method according to claim 9, comprising a step for the reading, by said conversion device, of said piece or pieces of configuration information on a detachable data carrier.

12. A method according to claim 1, wherein said digital command signal is of an IEEE 1394 type.

13. A method according to claim 12, comprising a step for the storage of data representing a configuration associated with said peripheral in a directory of said conversion device, said directory being compatible with the ConfigROM IEEE 1394 format.

14. A method according to claim 1, wherein the analog command signal is of a wireless type.

15. A method according to claim 1, wherein the analog command signal is of an infrared type.

16. A method according to claim 1, wherein pieces of data associated with said analog command signal are sent to said peripheral on the same transmission carrier.

17. A method according to claim 1, wherein pieces of data associated with said analog command signal are sent to said peripheral on a distinct transmission carrier.

18. A method according to claim 1, wherein said peripheral belongs to the group comprising:
camcorders;
television sets;
video recorders;
optical carrier readers; and
set-top boxes.

19. A device for the processing of command signals within an audiovisual network comprising at least one element of said network liable to send a digital command signal to at least one peripheral, called an analog peripheral, designed to receive analog commands, wherein the device comprises means for the conversion of said digital command signal into at least one of said analog commands, the conversion being selectively configured as function of said peripheral.

20. A device according to claim 19, comprising the following means:
means for the storage of at least one piece of configuration information representing said peripheral;
means for the reception of said digital command signal;
means for the conversion of said digital command signal into an analog command signal taking account of said piece or pieces of configuration information; and
means for the transmission of said analog command signal to said analog peripheral.

21. A device according to claim 20, comprising means for the initial reception of said pieces or pieces of configuration information of said peripheral transmitted by an element of said network.

22. A device according to claim 20, comprising means for the reading of said piece or pieces of configuration information on a detachable data carrier.

23. A device according to claim 20, wherein said device comprises means for the reading of said piece or pieces of configuration information on a detachable data carrier and wherein said reading means themselves comprise means for the decoding of mechanical elements belonging to said carrier and representing said peripheral.

24. A device according to claim 20, wherein said device comprises means for the reading of said piece or pieces of configuration information on a detachable data carrier and wherein said carrier belongs to the group comprising:
smart cards;
magnetic carriers; and
optical carriers.

25. A device according to claim 20, wherein said conversion device implements means to verify the validity of said digital command signal as a function of said piece or pieces of configuration information.

26. A device according to claim 19, said device being independent of the audiovisual network element or elements and of said analog peripheral or peripherals.

27. A device according to claim 19, comprising means for the storage of at least one piece of conversion information representing a set of commands accepted by said peripheral.

28. A device according to claim 27, wherein said pieces of conversion information are transmitted preliminarily by one of said elements of the network to said device.

29. A device according to claim 27, comprising means for the reading of said piece or pieces of configuration information on a detachable data carrier.

30. A device according to claim 19, wherein said digital command signal is of an IEEE 1394 type.

31. A device according to claim 30, comprising means for the storage of data representing a configuration associated with said peripheral in a directory compatible with the ConfigROM IEEE 1394 format.

32. A device according to claim 19, wherein the analog command signal is of a wireless type.

33. A device according to claim 19, wherein the analog command signal is of an infrared type.

34. A device according to claim 19, comprising means for the transmission of data associated with said analog command signal to said peripheral on the same transmission carrier.

35. A device according to claim 19, comprising means for the transmission of data associated with said analog command signal to said peripheral on a distinct transmission carrier.

36. A device according to claim 19, wherein said peripheral belongs to the group comprising:
camcorders;
television sets;
video recorders;
optical carrier readers; and
set-top boxes.

37. An audiovisual communications network comprising:
at least one peripheral, called an analog peripheral, designed to receive analog commands;
at least one element liable to send a digital command signal to said analog peripheral; and
at least one command signals processing device comprising means for the conversion of said digital command signal into at least one of said analog commands, said conversion being selectively configured as a function of said peripheral.

38. A computer program product comprising program elements, recorded on a carrier readable by at least one microprocessor designed to be implemented in a device for the processing of command signals within an audiovisual network comprising at least one element liable to send a digital command signal to at least one peripheral designed to receive analog commands, wherein said program elements control said microprocessor or microprocessors so that, in said processing device, they carry out a conversion of said digital command signals into at least one of said analog commands, the conversion being selectively configured as a function of said peripheral.

39. A computer program product, comprising sequences of instructions adapted to the implementation of a method for the processing of command signals according to claim 1, when said program is executed on a computer.
